(19) United States
(12) Patent Application Publication
(10) Pub. No.: US 2018/0060500 A1
(43) Pub. Date: Mar. 1, 2018

(54) SMART HEALTH ACTIVITY SCHEDULING

(71) Applicant: Microsoft Technology Licensing, LLC, Redmond, WA (US)

(72) Inventors: Tachen C. Ni, Bellevue, WA (US); Ryen William White, Woodinville, WA (US); Jessica Lundin, Seattle, WA (US)

(73) Assignee: Microsoft Technology Licensing, LLC, Redmond, WA (US)

(21) Appl. No.: 15/251,911

(22) Filed: Aug. 30, 2016

(51) Int. Cl. G06F 19/00; G06Q 10/10

(52) U.S. Cl. CPC G06F 19/324; G06Q 10/1097; G06F 19/3481

(57) ABSTRACT

Examples are disclosed herein that relate to integrating health data and work data of one or more users and recommending a time to perform a health activity. One example provides a computing device configured to receive health data relating to health behavior, the health data comprising information regarding a relationship between health activity scheduling and health outcome, receive work data relating to work activities, compare the health data and the work data to determine a time at which to recommend performing a health activity, and output a recommendation regarding the time to perform the health activity.

### BACKGROUND

Electronic devices, such as wearables and smart phones, may be configured to track and output information regarding physiological and behavioral characteristics of a person, such as health and fitness data. Such information may provide, for example, insights on the impact of exercise on a person's health characteristics.

### SUMMARY

Examples are disclosed herein that relate to integrating health data and work data of one or more users and recommending a time to perform a health activity based upon the trends and characteristics of the one or more person's work and fitness habits. One example provides a computing device configured to receive health data relating to health behavior, the health data comprising information regarding a relationship between health activity scheduling and health outcome, receive work data relating to work activities, compare the health data and the work data to determine a time at which to recommend performing a health activity, and output a recommendation regarding the time to perform the health activity.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A shows an example user interface for a personal calendar on a computing device, and illustrates an example personal health activity scheduling alert.

FIG. 1B shows another example user interface for a personal calendar on a computing device, and illustrates another example personal health activity scheduling alert.

FIGS. 2A and 2B show an example wearable electronic device that may be used in health activity scheduling.

FIG. 3 shows a block diagram of an example use environment for health activity scheduling.

FIGS. 4A and 4B shows an example method of providing a recommendation related to a health activity.

FIG. 5 shows a block diagram of an example computing system.

### DETAILED DESCRIPTION

As mentioned above, various electronic devices, such as wearable or mobile devices, may be configured to track health and fitness-related data for a user based on sensor data. For example, a mobile device may use location sensors and motion sensors to track movements of the user over time. This data then may be used to determine information such as calories burned, distance traveled, average speed traveled, and inactive time information. Wearable devices may comprise additional sensors, such as sensors useable to detect heart rate and heart rate variation, blood pressure, blood oxygenation, skin temperature, and galvanic skin response, as non-limiting examples. Such information may help a user to understand instantaneous health status, as well as to determine trends in the user's health characteristics over time. However, such devices may not provide insight into factors that may influence health characteristics over time, such as times at which exercise is more efficient and/or times at which exercise may improve sleep quality. Such devices also may not provide feedback on how to vary such factors to help achieve a personal health outcome of interest.

Accordingly, examples are disclosed herein that relate to providing user-specific feedback and recommendations regarding personal health activity scheduling. As described in more detail below, the disclosed examples may consider a user's work data together with health data for the user to provide recommendations that may help a user to achieve a health-related outcome of interest. Example health data may include such information as exercise efficiency and exercise benefits and/or sleep quality as a function of exercise schedule and behavior, while example work data may include calendar data and other information regarding habits and obligations associated with work (e.g., patterns in sending and receiving electronic email). The term “work” as used herein may signify work activities and obligations associated with an occupation, including but not limited to jobs performed at work, work meetings, phone calls, homework, classes, commutes to and from work/school, and business trips, as well as work activities beyond those associated with an occupation, including but not limited to housework, chores, and errands. Further, “work data” may signify scheduled or habitual activities associated with work. Work data may also include metrics related to work efficiency, such as rate of jobs or tasks completed, emails sent, keystrokes, mouse clicks, web searches, etc. Further, other obligations besides work may also be considered, including but not limited to social, family or entertainment events on a user's calendar. More detailed examples of health data, work data, and the comparison of health data and work data are described below.

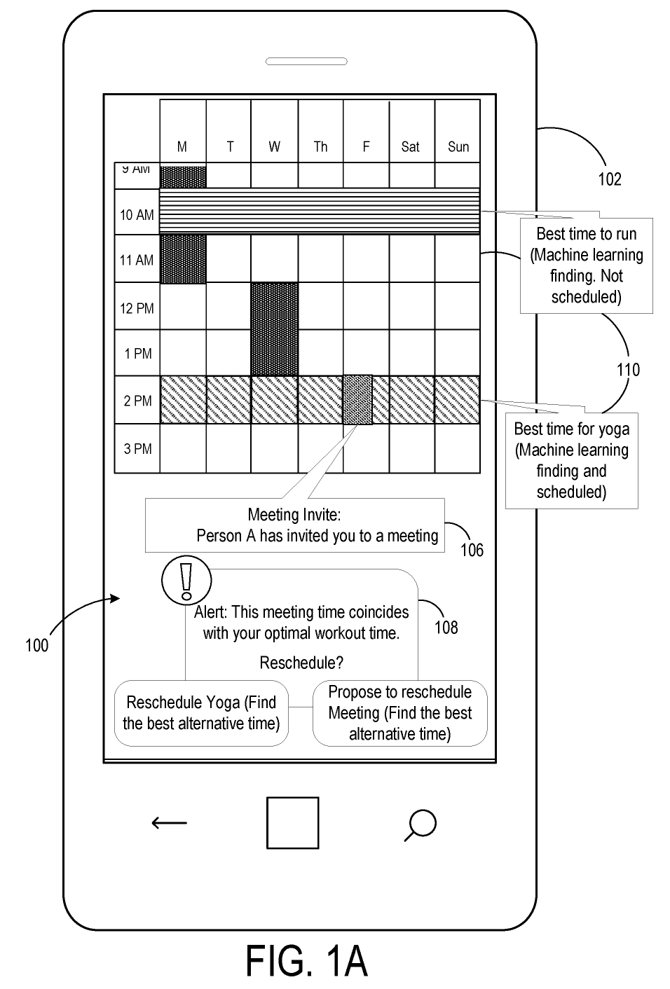

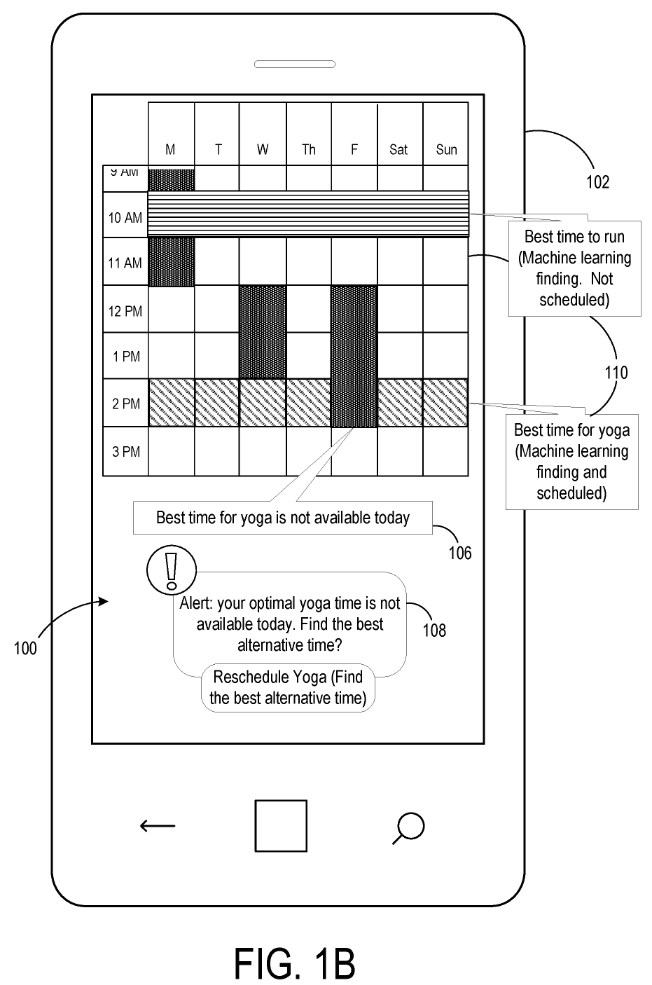

FIG. 1A shows an example calendar user interface 100 on a mobile device 102. User interface 100 includes a user calendar 104, a meeting invitation 106, an alert 108 and best time for activities 110. In this example, the meeting invitation 106 requests the user to attend a meeting during a time period which overlaps with an already scheduled block of time 110 reserved for a user workout (e.g. yoga) based on recommendation from the machine learning algorithms. This scheduled workout time may be a user-scheduled workout time, or a programmatically-suggested workout time that was previously determined, recommended and scheduled for the user based upon the user's health data and work data, as described in more detail below.

Upon receipt of the invitation, it may be determined that the new meeting invitation 106 coincides with the previously scheduled workout time. In this instance, the user interface 100 displays the alert 108 to warn the user that the proposed meeting time conflicts with the previously scheduled workout time. The depicted alert 108 also provides the user with an option of either rescheduling the workout, or rescheduling the meeting. In other examples, an alert may provide any other suitable information and/or proposed action(s). Upon user selection of “Reschedule Yoga”, the device 100 may, for example, recommend an alternate time for a user workout that is determined to be beneficial based upon the user's personal health data, and that does not coincide with the time of the meeting or other scheduled events. The term “optimal workout time” and the like may signify that the suggested workout time may have been determined from an algorithm configured to optimize a composite objective with respect to customizable configurations. As one example, an algorithm may be utilized to increase exercise efficiency and reduce calendar fragmentation. These terms are not intended to indicate that the suggested workout time is determined to be a most optimal workout time, but instead that the suggested time is determined to potentially be comparatively better than other available times based upon health data and also work data.

FIG. 1B shows another example use case in which a pre-existing meeting prevents a user from working out at the routine time block. In this instance, the user interface 100 displays the alert 108 to warn the user that the workout time is not available and provides an option to find the best alternative time during the day.

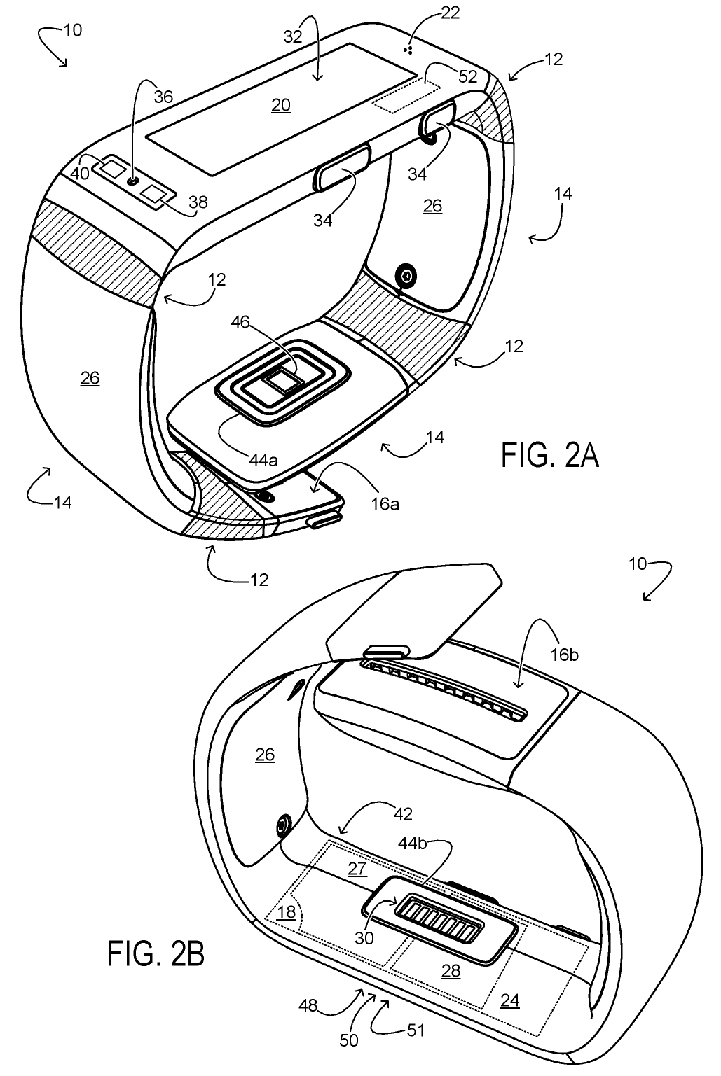

Health data and work data may be obtained from various sources. For example, health data and work data may be determined from sensor data acquired via a wearable or portable sensor system. FIGS. 2A and 2B show aspects of an example sensory-and-logic system in the form of a wearable electronic device 10 that may be configured to track health data and work data, and/or provide sensor data (raw or processed) to a remote device, such as a mobile or desktop computing device, for analysis. The illustrated device is band-shaped and may be worn around a wrist. The depicted wearable electronic device 10 includes a plurality of flexion regions 12 linking less flexible regions 14. The flexion regions 12 of the wearable electronic device 10 may be elastomeric in some examples. Fastening componentry 16a and 16b is arranged at both ends of the wearable electronic device 10. The flexion regions 12 and fastening componentry 16a and 16b enable the wearable electronic device 10 to be closed into a loop and to be worn on a user's wrist. In other examples, wearable electronic devices of a more elongate band shape may be worn around the user's bicep, waist, chest, ankle, leg, head, or other body part. In such an example, a wearable electronic device may take the form of eye glasses, a head band, an arm-band, an ankle band, a chest strap, or an implantable device to be implanted in tissue.

The wearable electronic device 10 includes various functional components integrated into less flexible regions 14. For example, the wearable electronic device 10 includes a computing system 18, display 20, loudspeaker 22, communication suite 24, and various sensors. These components draw power from one or more energy-storage cells 26.

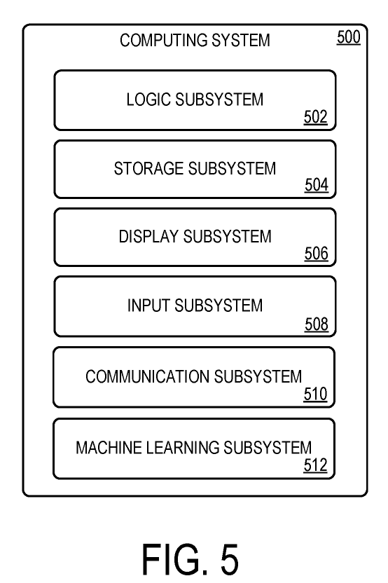

In the wearable electronic device 10, the computing system 18 is situated below the display 20 and operatively coupled to the display 20, along with the loudspeaker 22, the communication suite 24, and the various sensors and other components not depicted (e.g. haptic outputs, such as piezoelectric vibrators). The computing system 18 includes a data-storage machine 27 to hold data and instructions, and a logic machine 28 to execute the instructions. Aspects of the computing system 18 are described in further detail with reference to FIG. 5.

The communication suite 24 may include any appropriate wired or wireless communications componentry. In FIGS. 2A and 2B, the communication suite 24 includes USB port 30, which may be used for exchanging data between the wearable electronic device 10 and other computer systems, as well as providing recharge power. The communication suite 24 may further include two-way Bluetooth, Wi-Fi, cellular, near-field communication and/or other radios. In some examples, the communication suite may include an additional transceiver for optical, line-of-sight (e.g., infrared) communication.

In the wearable electronic device 10, touch-screen sensor 32 is coupled to display 20 and configured to receive touch input from the user. Pushbutton sensors may be used to detect the state of push buttons 34, which may include rockers. Input from the pushbutton sensors may be used to enact a home-key or on-off feature, control audio volume, turn the microphone on or off, etc.

FIGS. 2A and 2B show various other example sensors. Such sensors include microphone 36, visible-light sensor 38, ultraviolet sensor 40, and ambient temperature sensor 42. The microphone 36 provides input to the computing system 18 that may be used to measure the ambient sound level or receive voice commands from the wearer. Input from the visible-light sensor 38, ultraviolet sensor 40, and ambient temperature sensor 42 may be used to assess aspects of the wearer's environment—e.g., the temperature, overall lighting level, and whether the wearer is indoors or outdoors.

FIGS. 2A and 2B further show a pair of contact sensor modules 44a and 44b, which contact the wearer's skin when the wearable electronic device 10 is worn. The contact sensor modules 44a and 44b may include independent or cooperating sensor elements to provide a plurality of sensory functions. For example, the contact sensor modules 44a and 44b may provide an electrical resistance and/or capacitance sensory function responsive to the electrical resistance and/or capacitance of the wearer's skin, and thus may be configured to function as a galvanic skin response sensor. In the illustrated configuration, the separation between the two contact sensors provides a relatively long electrical path length for more accurate measurement of skin resistance compared to a shorter path. Further, in some examples, a skin temperature sensor may be integrated into one or both of contact sensor modules 44a and 44b to provide measurement of the wearer's skin temperature.

The wearable electronic device 10 may also include motion sensing componentry, such as an accelerometer 48, gyroscope 50, and magnetometer 51. The accelerometer 48 and gyroscope 50 may furnish inertial and/or rotation rate data along three orthogonal axes as well as rotational data about the three axes, for a combined six degrees of freedom. This sensory data can be used to provide a pedometer/calorie-counting function, for example. Data from the accelerometer 48 and gyroscope 50 may be combined with geomagnetic data from the magnetometer 51 to further define the inertial and rotational data in terms of geographic orientation. The wearable electronic device 10 may also include a global positioning system (GPS) receiver 52 for determining the wearer's geographic location and/or velocity. In some configurations, the antenna of the GPS receiver 52 may be relatively flexible and extend into flexion regions 12.

The computing system 18, via the sensory functions described herein, is configured to acquire various forms of information about the wearer of the wearable electronic device 10. Such information must be acquired and used with utmost respect for the wearer's privacy. Accordingly, the sensory functions may be enacted subject to opt-in participation of the wearer. In implementations where personal data is collected on the wearable electronic device 10 and transmitted to a remote system for processing, that data may be anonymized. In other examples, personal data may be confined to the wearable electronic device 10, and only non-personal, summary data is transmitted to the remote system.

It will be understood that any other suitable sensors not shown in FIG. 2 may be included on the wearable electronic device 10, such as a heart rate monitor, one more optical sensors, a barometer to detect changes in atmosphere pressure, an actigraph/actimetry sensor to monitor sleep behavior, etc. It will further be understood that although FIG. 2 shows a wearable device, the methods and techniques described herein may be operated on any other suitable computing device, including a desktop computing device, a mobile computing device, other wearable computing devices, and computing devices without sensors that may receive data remotely from a sensory-and-logic device such as wearable electronic device 10.

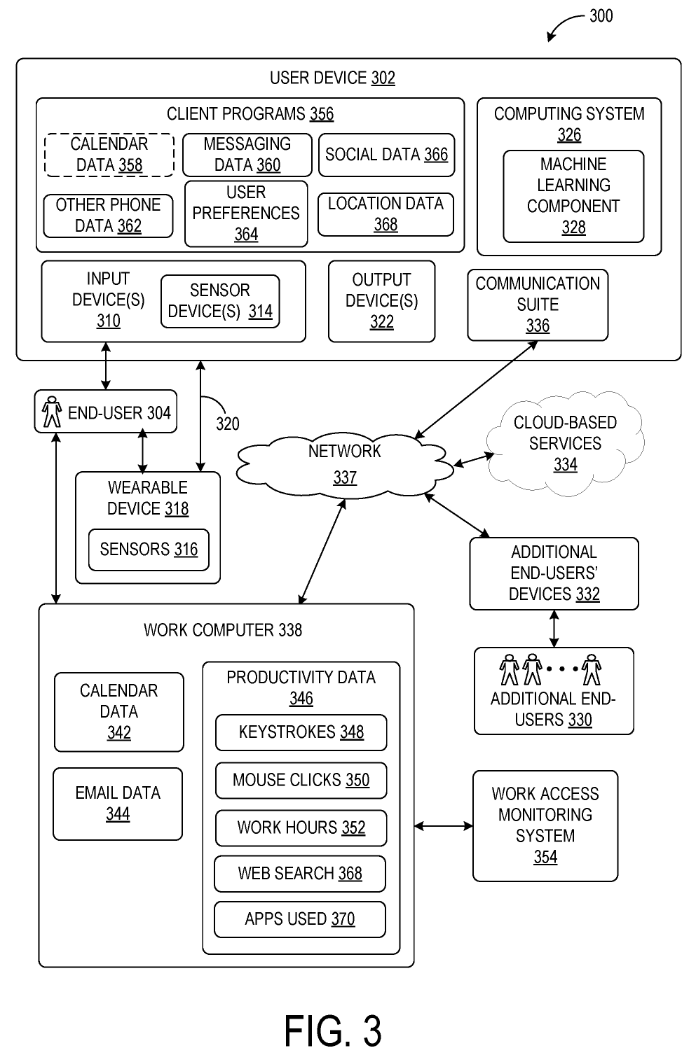

FIG. 3 shows an example use environment 300 including a user device 302 associated with end-user 304. The user device 302 may correspond to any suitable computing apparatus configured to process user health data and work data, such as a smartphone, a tablet, a laptop computer, or a desktop computer. Device 10 of FIG. 2 is an example of user device 302. Additional end-users' device(s) 332, associated with additional end-users 330, may take similar forms.

The user device 302 includes one or more input devices 310, such as a touch sensor (integrated with or separate from a display), a keyboard and/or a mouse. The input devices 310 also may include one or more sensor devices 314. In other examples, a user device may not include sensor devices 314, but may receive sensor data from sensors residing on another device, such as from sensors 316 on wearable device 318. Examples of the wearable device 318 include wrist or ankle-worn devices, head-mounted devices, and clip-on devices, configured to communicate with the user device 302, e.g. via a wired or wireless communication link 320. The user device 302 also includes one or more output devices 322, such as a display, a speaker, and/or a haptic output mechanism. Examples of sensor devices 314 or sensors 316 include one or more image sensors (e.g. video camera(s) and/or depth camera(s)), one or more microphones, one or more motion sensors (e.g. accelerometers, gyroscopes, magnetometers, etc.), an ultraviolet light sensor, an ambient temperature sensor, a galvanic skin response sensor, a skin temperature sensor, an optical heart rate sensor, a GPS sensor, and a barometer. Raw output from such sensors may be analyzed, for example by a computing system 326 of the user device 302 or directly on the wearable device 318, to determine quantities such as user movements, heart rate, blood pressure, blood oxygenation, calories burned, and sleep-related characteristics (e.g. a number of and frequency of wakeups, cardiovascular activity during sleep, etc.) as a function of time. This information may then be further analyzed to determine measures of sleep quality and one or more exercise benefits, such as exercise efficiency.

Temporal information regarding sleep quality, exercise benefits, and other such health characteristics may be correlated with user activities to determine health data for the user, wherein health data comprises information regarding a relationship between personal health activity scheduling and personal health outcome. Such relationships may include, for example, health benefits and health efficiencies achieved based on the types of user activities performed, the times at which activities are performed, and the duration of the activities, compared to exercise benefits, exercise efficiency, sleep quality, and other outcomes (e.g. body weight, body mass index, and weight loss). In addition to sensor data collected by the user device 302, relationships between personal health activity scheduling and personal health outcome also may be determined based at least partially on user inputs. User inputs may be used, for example, to indicate an activity type being performed, an input activating an exercise mode on the user device 302, and/or any other suitable data useable to correlate health outcome with activity scheduling.

Any suitable correlations between personal health activity scheduling and health outcomes may be determined. For example, the computing system 326 may determine from sensor data that higher exercise efficiency (e.g. calories burned per minute) may be achieved when the user exercises in the morning as opposed to during the evening. As another example, the computing system 326 may determine that days in which the user works out in the morning are correlated with better sleep quality compared to days when the user works out in the evening. As other examples, the computing system 326 may determine that days in which the user performed low-impact exercise (e.g. yoga) were correlated with better sleep quality compared to days in which the user performed strenuous exercise (e.g. vigorous running) The computing system 326 may also detect a correlation between better sleep quality and higher work productivity the next day. In some examples, such correlations also may be determined directly on wearable device 318.

Raw and/or processed sensor data may be analyzed to produce health data in any suitable manner. For example, the computing system 326 may comprise a machine-learning component 328 to apply machine-learning models and algorithms to the acquired sensor data. The machine-learning component 328 may be trained based on tracked user activity and user health metrics, either for the user or for a broader population of users, to determine relationships between health activities and health outcomes. Such machine-learning components also may be incorporated into wearable device 318. In some examples, population-based health data may be initially used to recommend health activity scheduling for a new user for whom little personal data has been accumulated. Such population data may be obtained from additional end-users 330 and their devices 332 via cloud-based services, illustrated schematically at 334. As the end-user 304 continues to use the user device 302, personal data may be applied to analysis as it is gathered. Personal data may eventually override the population data with time.

The machine-learning component 328 may implement any suitable algorithms or techniques. Examples include exploratory factor analysis, multiple correlation analysis, support vector machine, random forest, gradient boosting, decision trees, boosted decision trees, generalized linear models, partial least square classification or regression, branch-and-bound algorithms, neural network models, deep learning algorithms, clustering models, association rule learning, and symbolic computation engines.

Health data may be used to provide various recommendations to a user. For example, health data regarding sleep quality, exercise benefits, exercise efficiency, and other suitable outcomes as a function of activities performed and/or times at which activities are performed may be used to suggest times to perform personal health activities, and/or personal health activities to perform at those times.

However, a user may have many obligations during a day that can interfere with the user's ability to perform the suggested activities at the suggested times. For example, analysis of health data alone may indicate that working out in the morning is associated with certain health benefits. However, if the user typically is at work all throughout the morning, then a recommendation to exercise in the morning may not be useful to the user.

Thus, health data may be utilized in combination with work data related to a user's work activities to determine times to suggest performing personal health activities. In FIG. 3, the user device 302 may have access via communication suite 336 and network 337 to work data, such as calendar data 342, on a work computer 338 of the end user 304, wherein the work data regards a personal work schedule and/or work habits of the end-user 304. The calendar data 342 may inform the user device 302 of a personal work schedule of the end-user 304, which may be used to suggest workout times which are available to the user for performing health activities.

Work data may also be determined or inferred from other suitable data besides calendar data 342. For example, email data 344 accessible from the work computer 338 may help provide data related to times of work meetings and events, as determined from email content, keywords, invitations, etc. Further, email data 344 may also provide information relating to times when a user is logged in to a work email address or has received and sent email correspondences, indicating that the user may likely be working. As another example, work data may be inferred from sensor data provided by the user device 302 and/or the wearable device(s) 318, such as sensor data indicating when the user has been sitting for an extended period of time, GPS data indicating when the user is at a work location, etc.

Work data may further include information related to work productivity of the end-user 304, such that personal health activity scheduling may also be correlated with work productivity. Productivity data 346 may include, for example, information regarding keystrokes 348, mouse clicks 350, work hours 352 logged, web search activities 368 and/or applications in use 370 via the work computer 338. Other examples of productivity data include tasks completed, emails answered (as determined from email data 344), number of print jobs, time spent in screensaver/sleep mode, word count of documents drafted, etc. In some examples, hours worked may also be accessible from a work access monitoring system 354 used by an employer, such as an employee time entry system, work timesheets, employee work schedules, employee premises access information (e.g. security badge information), and/or payroll.

The user device 302 also may include client programs 356 including client-side calendar functionality, which may reflect the calendar data 342 on the work computer 338. The client programs 356 may also provide various messaging data 360, social data 366, location data 368, user preferences 364 and other phone data 362. Similar to the email data 344, the messaging data 360 may help to inform when the user may have obligations, e.g. from analysis of the content of text invitations, alerts, reminders, and the like. The phone data 362 may provide similar information, e.g. from conversation or voicemail content. Work data may also be received via user input of work hours during an initial configuration or other user input process. As yet another example, work data may also be inferred from GPS data, which may indicate when a user is at a work location.

In some examples, preferences of the end-user 304 may be used to further inform scheduling of events. As such, the client programs 356 may include data regarding user preferences 364. Such preferences may be input by a user, or may correspond to user patterns learned over time. User preferences 364 may comprise any suitable information, such as information regarding when the end-user 304 prefers to work out, a preferred duration of workouts, a prioritization of work meetings compared to personal health activities, etc.

The user device 302 may also interact with any suitable additional user devices such as another wearable device, another mobile device, a desktop personal computing device, a laptop computing device, a game console device, a set-top box device, or a tablet-type computing device, as examples. Additional user devices may provide any other suitable data for use in helping to recommend scheduling of events.

The computing system 326 may utilize any or all of the above types of data in combination to compare work data and health data to determine one or more optimal times at which to recommend performing a personal health activity. Any suitable comparison may be used. Examples include association methods including but not limited to exploratory factor analysis, multiple correlation analysis, support vector machine, random forest, gradient boosting, decision trees, boosted decision trees, generalized linear models, partial least square classification or regression, branch-and-bound algorithms, neural network models, deep learning algorithms, clustering models, association rule learning, and symbolic computation engines. It will be understood that such computations may additionally or alternatively be performed by any other suitable computing device(s) other than the user device 302.

Determining one or more association(s) between the work data and health data may help to generate recommendations to schedule workouts at times determined to potentially have a positive impact on exercise efficiency, sleep quality, work productivity, and/or any other suitable personal health outcome. The objective function for the association can be defined as follows. For example, in device 302 of FIG. 3, the machine learning component 328 can generate a composite score CS_{D}^{Z} for a particular candidate time slot Z based on a sum of two components, one from health data HS_{D}^{Z} and one from work data WS_{D}^{Z}, for a particular candidate day D:

CS_{D}^{Z}=f(HS_{D}^{Z}, WS_{D}^{Z}),

where f(x, y) can be any function to compute the composite score, including but not limit to additive f(x, y)=x+y, or multiplicative f(x, y)=x*y

To find a determined optimal time to schedule a workout, the machine learning module will use algorithms such as those listed in [0027] to maximize the likelihood of best scores CS_{D}^{Z} by varying Z (time) and D (Date, if applicable) and compute scores from users past and present data.

For example, if it is determined that a user is more efficient (HS=workout efficiency) when exercising in the morning rather than in the evening (HS_{D}^{Morning}>HS_{D}^{Afternoon}), but the user typically has busy mornings (low WS_{D}^{Morning}), or has calendar events scheduled in the morning with little free time (low WS_{D}^{Z} defined as “continuous free time blocks”), the computing system 326 may determine an optimal workout time to be in the early afternoon. In some examples, the computing system 326 may also consider scheduling events such that the user has more continuous free time (high WS_{D}^{Z} defined as “continuous free time blocks”), as opposed to scheduling events spaced apart from one another. For instance, if the user currently has an open block of free time of 1.5 hours in between a scheduled workout and another scheduled event, the computing system 326 may recommend scheduling them back-to-back in order to free up more continuous time before and/or after the events, e.g. to allow the user to get back to work, and potentially increase work productivity.

Further, the computing system 326 may optimize scheduling for multiple endpoints based on a weighted scoring system shown below.

CS_{D}^{Z}=f(w^{health}*HS_{D}^{Z}, w^{work}*WS_{D}^{Z}),

where f(x,y) can be any function to compute the composite score; and weighting factors w^{health} and w^{work} are defined or derived from health data and work data respectively. The method can be generalized to be applied to team based workouts or sport events, where multiple participants are involved. The generalized form of the scoring system can be described by the equation below.

$${CS}_{D}^{Z} = {\sum }_{i = 1}^{N} f ( {w}_{i}^{health} * {HS}_{i , D}^{Z} , {w}_{i}^{work} {WS}_{i , D}^{Z} ) ,$$

where f(x,y) can be any function to compute the composite score; and i=1 . . . N are individual scores from each of the N participants.

In one example, if exercise is a priority to the end-user 304, e.g. as determined user preferences 364, an exercise time slot may be given more weight than that given to continuous free time blocks (w^{health}>>w^{healthwork}). Such weightings may be user-assigned, or may be determined algorithmically and change with machine learning. As a more specific example, sensor data may show that a user has had poor sleep quality for the past three nights, while analysis of the user's past health data shows that running during the day helps the user to sleep better. Thus, as the user continues to experience poor sleep quality for additional nights, the recommendation to run during the day may be given a higher weighting (higher w^{health}). In other examples, inputs and outcomes may be given equal weighting (w^{health}=w^{work}), such as by default.

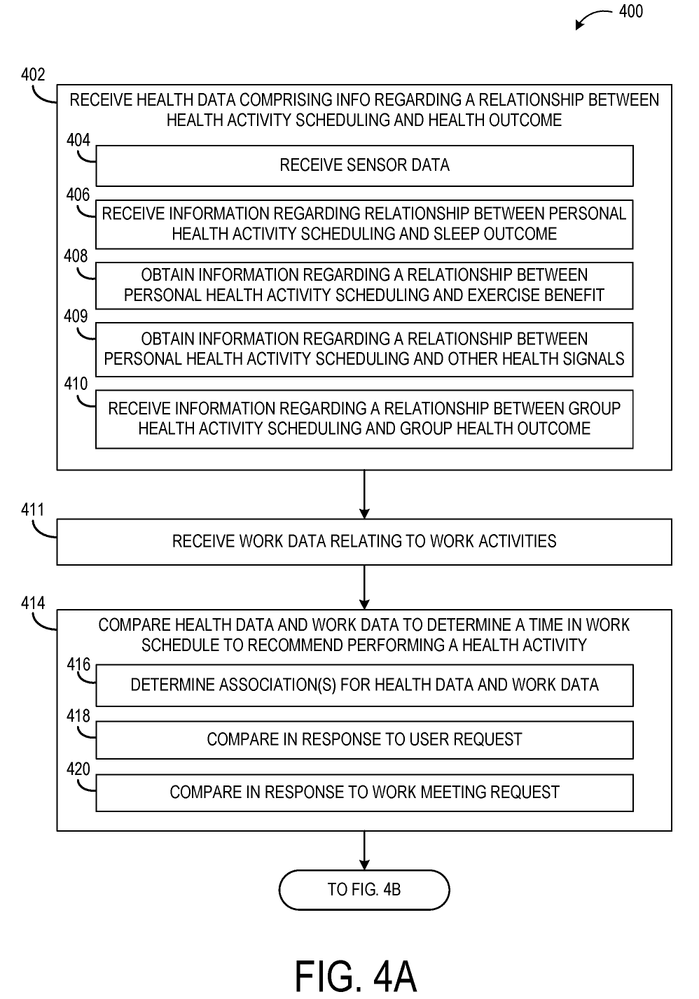

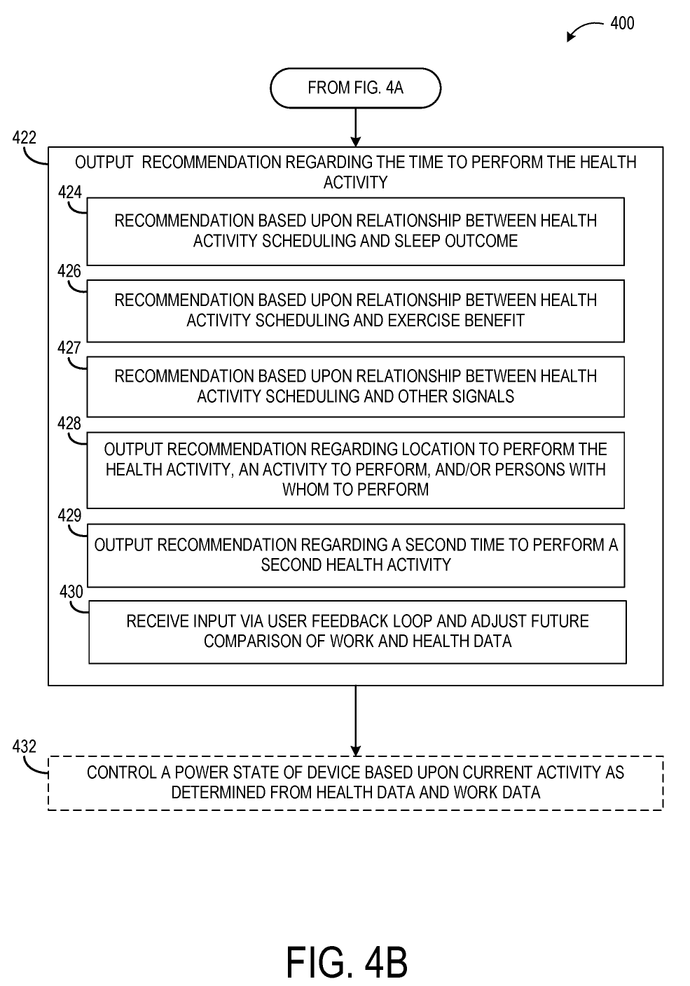

FIGS. 4A and 4B show an example method 400 of integrating health data and work data to recommend a health activity, wherein the term “integrating” signifies that both types of data are considered in determining the recommendation or recommendations. The method 400 may be implemented on any suitable user device, such as the wearable electronic device 10, mobile device 102, or another computing device (e.g. a desktop, laptop, tablet, HMD or other wearable) in communication with a wearable or mobile device. The method 400 includes, at 402, receiving health data relating to health behavior of one or more users. The health data may comprise information regarding a relationship between health activity scheduling and a health outcome. In some examples, health data may include data relating to personal health activities of a user of the user device implementing the method 400, while in other examples health data may include data relating to group health activities involving multiple participants, such as team sports. As such, additional data from one or more people other than the user may be obtained to determine health data regarding a relationship between scheduling of a group health activity and a group outcome, such as averaged health outcomes of each person in the group, or group performance outcomes. Such groups may be defined based upon any suitable commonality, such as a social group, a work group, a sports team, etc.

The health data may be at least partially derived from sensor data, as indicated at 404, such as data from various sensors on a wearable device and/or a mobile device. Such sensor data may include data relating to heart rate, skin temperature, galvanic skin response, number of steps taken, calories burned, sleep quality, and/or other suitable sensor data. Health data also may be received via user input, from population data models, e.g., average health data related to persons of similar age, weight, height, race, gender, etc., and/or from any other suitable source.

The sensor data may be analyzed to determine health data in the form of personal health outcomes, e.g. health benefits and efficiencies, related to the performing of certain health activities. Examples of personal health outcomes include sleep quality (e.g. hours slept, restlessness during sleep), exercise efficiency (e.g. calories burned per minute, total calories burned, heart rate), and potentially other outcomes such as body weight, body mass index, and weight loss. As a more specific example, the method 400 may include, at 406, obtaining information regarding a relationship between personal health activity scheduling and sleep outcome. The information may be obtained from a remote device, or obtained locally by processing relevant data received as inputs. In such an example, the user device may determine that the user typically sleeps better at night (e.g. more hours slept) when the user has exercised in the morning versus at night. As another more specific example, the method 400 may include, at 408, obtaining information regarding a relationship between personal health activity scheduling and an exercise benefit. In such an example, a user device may analyze past exercise behavior and determine that more calories are burned per minute when the user exercises in the morning than at night. This approach can be extended to any other health signals, such as daily total steps, at 409.

As mentioned above, health outcomes related to the health benefits and efficiencies of a group of people may also be considered. Thus, the method 400 also may include, at 410, receiving information regarding a relationship between group health activity scheduling and a group health outcome.

The method 400 further includes, at 411, receiving work data relating to the user's work activities, which may include personal and group work activities. Work data may include data such as hours worked, time spent at the office/work facility, work-related events such as meetings or business travel, and work productivity (e.g. keystrokes, mouse clicks, tasks completed, web searches performed or applications used). Work data may be obtained in any suitable manner. As described above, in some examples, work data may be directly input by the user, and/or may be obtained from the user's calendar data in which the user has previously input a work schedule. In other examples, work data may be inferred, such as from GPS data that may indicate a user going to and from a work location, or from email data that may indicate when a user is logged in to a work email address or has received and sent email correspondences related to work. In yet other examples, work data may be obtained from a work access monitoring system used by an employer, including an employee time entry system, work timesheets, employee work schedules, payroll, etc.

The method 400 further includes, at 414, comparing the health data and the work data to determine a time in a work schedule, such as the user's work schedule or a group work schedule, to recommend performing a personal health activity. Performing this comparison may comprise determining one or more association(s) between the health data and the work data, at 416. Determining association(s) may take into account user preferences, correlations between health activity scheduling and health outcomes, personal health data, population health data, continuous free time in a user's calendar, weightings to optimize for certain endpoints, and/or any other suitable factors.

The comparison of the health data and the work data may be triggered by certain events, or automatically performed on a periodic basis. As one example, the comparison may be triggered in response to a user request 418, for example, when the user requests a recommendation of a time to work out. As another example, the comparison may be triggered in response to receiving a work meeting request, as shown at 420, such as via text, email, phone call, calendar invite, etc. As described by example above in regard to FIG. 1, a new work meeting request may occupy a previously scheduled block of time for exercise. As such, the device may re-compare the calendar data to the health data, and determine another optimal time when the user may perform the personal health activity. Any other suitable event may be used to trigger the comparison of health data to work data.

Continuing with FIG. 4B, the method 400 further includes, at 422, outputting a recommendation regarding the time determined to perform the personal and/or group health activity. The recommendation may be based upon a relationship between health activity scheduling and sleep outcome, as shown at 424. For example, if it is determined that the user sleeps better at night when the user exercises in the morning versus at night, the recommendation may include a suggested exercise time during a morning period not currently occupied by work or other events, e.g. before work. The recommendation may also be based upon a relationship between health activity scheduling and an exercise benefit, such as exercise efficiency, as shown at 426. For example, if it is determined that the user typically burned more calories per minute at 8 AM after eating breakfast than at 6 AM when the user got out of bed, the recommendation may include a suggestion to exercise at 8 AM. It will be understood that the recommendation regarding the time to perform the personal health activity may not necessarily include a fixed time, but may include a time in relation to other times and events. Continuing with the above example, the recommendation may include a general suggestion to perform the personal health activity after eating breakfast, before work, etc. This approach can be generalized to any other signals, including but not limited to total daily steps, daily moving distances or work productivity, at 427.

Other recommendations also may be output. For example, as indicated at 428, the method 400 may include outputting a recommendation regarding a location at which to perform the health activity, an activity to perform, and/or one or more person(s) with whom to perform the health activity. For example, if it is determined that running outdoors typically burned more calories per minute for the user compared to running on a treadmill, the recommendation may include a suggestion to run outdoors. The method 400 further may include, at 429, outputting a recommendation regarding a second time to perform a second health activity. Any suitable number of and/or type of recommendations may be output regarding health activities as determined from the comparison of health data and work data. Additionally, the user may choose to schedule any or all of the recommended health activities presented. A user feedback loop may be further implemented, at 430, to incorporate user preferences and assessments to improve recommendation efficiency, for example, by adjusting a future comparison of work and health data.

In some examples, health data and work data may be further utilized to determine times in which the user may not need to operate the mobile device, wearable device, desktop computer, etc. which is implementing the method 400. For example, if it is determined that the user is scheduled to attend a work meeting from 2-4 PM, it is unlikely that the user will be operating the device during that time. Further, because attending a work meeting may not result in noteworthy changes in health metrics, e.g. heart rate, calories burned, etc., continuously acquiring sensor data during this period may also not be as important as gathering data at other times. Similarly, while working out in a gym or running outdoor, the user is unlikely to operate a desktop PC at the same time.

As such, the method 400 may further include, at 432, controlling a power state of the device and the desktop PC based upon a current activity being performed as determined from the health data and the work data. For example, continuing with the above example, from 2-4 PM the device may automatically power down to a sleep mode or power-saving mode, cease acquisition of some or all sensor data, or otherwise decrease the power consumption of the device. Upon the user's return from the work meeting, the device may then automatically power back up to a normal functioning mode. Having access to the user's personal work schedule may allow the device to control its own power state, and thus may help to conserve power compared to other health-monitoring devices which do not take into account a user's work schedule. In some examples, the device may also recommend a power state, for example by outputting a recommendation to the user to charge the device during the work meeting or to shut down the device during the work meeting. Similar scenarios can be applied to a user's desktop PC (and/or other device(s)) as well.

The methods and processes described herein may be tied to a computing system of one or more computing devices. For example, such methods and processes may be implemented as a computer-application program or service, an application-programming interface (API), a library, and/or other computer-program product.

FIG. 5 schematically shows an example computing system 500 that can enact one or more of the methods and processes described above. The computing system 500 is shown in simplified form. The computing system 500 may take the form of one or more personal computers, server computers, tablet computers, home-entertainment computers, network computing devices, gaming devices, mobile computing devices, mobile communication devices (e.g., smart phone), and/or other computing devices. The various computing devices and wearable devices described earlier herein may be examples of computing system 500.

The computing system 500 includes a logic subsystem 502 and a storage subsystem 504. The computing system 500 may optionally include a display subsystem 506, input subsystem 508, communication subsystem 510, and/or other components not shown in FIG. 5.

The logic subsystem 502 includes one or more physical devices configured to execute instructions. For example, the logic subsystem 502 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result. The logic subsystem 502 may also include a machine-learning component, as described above with regard to FIG. 3, configured to perform machine-learning algorithms on data.

The logic subsystem 502 may include one or more processors configured to execute software instructions. Additionally or alternatively, the logic subsystem 502 may include one or more hardware or firmware logic machines configured to execute hardware or firmware instructions. Processors of the logic subsystem 502 may be single-core or multi-core, and the instructions executed thereon may be configured for sequential, parallel, and/or distributed processing. Individual components of the logic subsystem 502 optionally may be distributed among two or more separate devices, which may be remotely located and/or configured for coordinated processing. Aspects of the logic subsystem 502 may be virtualized and executed by remotely accessible, networked computing devices configured in a cloud-computing configuration.

The storage subsystem 504 includes one or more physical devices configured to hold instructions executable by the logic subsystem 502 to implement the methods and processes described herein. When such methods and processes are implemented, the state of the storage subsystem 504 may be transformed—e.g., to hold different data.

The storage subsystem 504 may include removable and/or built-in devices. The storage subsystem 504 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. The storage subsystem 504 may include volatile, nonvolatile, dynamic, static, read/write, read-only, random-access, sequential-access, location-addressable, file-addressable, and/or content-addressable devices.

It will be appreciated that storage subsystem 504 includes one or more physical devices. However, aspects of the instructions described herein alternatively may be propagated by a communication medium (e.g., an electromagnetic signal, an optical signal, etc.) that is not held by a physical device for a finite duration.

Aspects of the logic subsystem 502 and storage subsystem 504 may be integrated together into one or more hardware-logic components. Such hardware-logic components may include field-programmable gate arrays (FPGAs), program-and application-specific integrated circuits (PASIC/ASICs), program- and application-specific standard products (PSSP/ASSPs), system-on-a-chip (SOC), and complex programmable logic devices (CPLDs), for example.

When included, the display subsystem 506 may be used to present a visual representation of data held by the storage subsystem 504. This visual representation may take the form of a graphical user interface (GUI). As the herein described methods and processes change the data held by the storage machine, and thus transform the state of the storage machine, the state of the display subsystem 506 may likewise be transformed to visually represent changes in the underlying data. The display subsystem 506 may include one or more display devices utilizing virtually any type of technology. Such display devices may be combined with the logic subsystem 502 and/or storage subsystem 504 in a shared enclosure, or such display devices may be peripheral display devices.

When included, the input subsystem 508 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, the communication subsystem 510 may be configured to communicatively couple the computing system 500 with one or more other computing devices. The communication subsystem 510 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow the computing system 500 to send and/or receive messages to and/or from other devices via a network such as the Internet.

The computing system 500 may further include machine learning subsystem 512 where data analytics and modeling tasks are performed. In some examples, the machine learning subsystem 512 may consume signals from the input subsystem 508 and output the results through the communication subsystems 510 and/or display subsystem 506. The machine learning subsystem 512 may have any suitable hardware and/or software configuration via the logic subsystem 502 and the storage subsystem 504.

Another example provides a computing device comprising a logic subsystem comprising a logic device, and a storage subsystem comprising a storage device, the storage subsystem comprising instructions executable by the logic subsystem to receive health data relating to health behavior, the health data comprising information regarding a relationship between health activity scheduling and health outcome. The instructions are also executable to receive work data relating to work activities, compare the health data and the work data to determine a time at which to recommend performing a health activity, and output a recommendation regarding the time to perform the health activity. The instructions executable to receive health data may additionally or alternatively comprise instructions executable to receive sensor data from a wearable device. The instructions may additionally or alternatively be executable to receive sensor data relating to one or more of heart rate, skin temperature, galvanic skin response, number of steps taken, calories burned, moving distance, standing time, sleep duration and sleep quality. The work activities may additionally or alternatively comprise one or more of meetings, emails, web searches, locations, applications used, a work schedules and work productivity. The instructions may additionally or alternatively be executable to compare the health data and the work data in response to a user request. The instructions may additionally or alternatively executable to automatically compare the health data and the work data in response to receiving a work meeting request. The health data may additionally or alternatively comprise information regarding a relationship between health activity scheduling and sleep outcome, and wherein instructions are executable to output a recommendation based upon the relationship between health activity scheduling and sleep outcome. The health data may additionally or alternatively comprise information regarding a relationship between health activity scheduling and an exercise benefit, and wherein the instructions are executable to output a recommendation based on the relationship between health activity scheduling and the exercise benefit. The health data may additionally or alternatively comprise information regarding a relationship between health activity scheduling and data regarding one or more of daily total steps and work productivity. The instructions may additionally or alternatively be executable to control a power state of the computing device based upon a current activity as determined from the health data and the work data. The instructions may additionally or alternatively be executable to receive work data relating to a work schedule via one or more of user input, a personal calendar, Global Positioning System data, user input data, email data, and a work access monitoring system. The instructions may additionally or alternatively be executable to output one or more of a recommendation regarding a location to perform the health activity, a recommendation regarding one or more persons with whom to perform the health activity, and a recommendation of an activity to perform.

Another example provides, on a computing device, a method, comprising receiving health data relating to health behavior of one or more users, the health data comprising information regarding a relationship between health activity scheduling and health outcome, receiving work data relating to work activities, comparing the health data and the work data to determine a time in a work schedule at which to recommend performing a health activity, and outputting a recommendation regarding the time in the work schedule to perform the health activity. Receiving health data may additionally or alternatively comprise receiving sensor data from a wearable device. Receiving sensor data may additionally or alternatively comprise receiving sensor data relating to one or more of heart rate, skin temperature, galvanic skin response, number of steps taken, calories burned, moving distances, standing time, sleep duration and sleep quality. The work activities may additionally or alternatively comprise one or more of meetings, emails, web searches, locations, applications used, work schedules and work productivity. The health data may additionally or alternatively comprise information regarding a relationship between health activity scheduling and one or more of a sleep outcome and an exercise benefit, and wherein the recommendation is based on the relationship between health activity scheduling and one or more of the sleep outcome and exercise benefit.

Another example provides a computing device, comprising a logic device; and a storage device comprising instructions executable by the logic device to receive sensor data from a sensor system, from the sensor data, determine health data relating to health behavior of one or more users, the health data comprising information regarding a relationship between health activity scheduling and health outcome, receive work data relating to a work schedule, compare the health data and the work data to determine a time in the work schedule at which to recommend performing a health activity, output a recommendation regarding the time in the work schedule to perform the health activity, and control a power state of the computing device based upon a current activity as determined from the health data and the work data. The health data may additionally or alternatively comprise information regarding a relationship between health activity scheduling and one or more of sleep outcome and an exercise benefit, and wherein instructions are executable to output a recommendation based upon the relationship between health activity scheduling and the one or more of sleep outcome and exercise benefit. The instructions may additionally or alternatively be executable to control a power state of one or more of a desktop computing device, a mobile computing device, and a wearable computing device based upon a current activity as determined from the health data and the work data.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device comprising:
a logic subsystem comprising a logic device; and
a storage subsystem comprising a storage device, the storage subsystem comprising instructions executable by the logic subsystem to receive health data relating to health behavior, the health data comprising information regarding a relationship between health activity scheduling and health outcome,
receive work data relating to work activities,
compare the health data and the work data to determine a time at which to recommend performing a health activity, and
output a recommendation regarding the time to perform the health activity.

2. The computing device of claim 1, wherein the instructions executable to receive health data comprise instructions executable to receive sensor data from a wearable device.

3. The computing device of claim 2, wherein the instructions are executable to receive sensor data relating to one or more of heart rate, skin temperature, galvanic skin response, number of steps taken, calories burned, moving distance, standing time, sleep duration and sleep quality.

4. The computing device of claim 1, wherein the work activities comprise one or more of meetings, emails, web searches, locations, applications used, work schedules and work productivity.

5. The computing device of claim 1, wherein the instructions are executable to compare the health data and the work data in response to a user request.

6. The computing device of claim 1, wherein the instructions are executable to automatically compare the health data and the work data in response to receiving a work meeting request.

7. The computing device of claim 1, wherein the health data comprise information regarding a relationship between health activity scheduling and sleep outcome, and wherein instructions are executable to output a recommendation based upon the relationship between health activity scheduling and sleep outcome.

8. The computing device of claim 1, wherein the health data comprise information regarding a relationship between health activity scheduling and an exercise benefit, and wherein the instructions are executable to output a recommendation based on the relationship between health activity scheduling and the exercise benefit.

9. The computing device of claim 1, wherein the health data comprise information regarding a relationship between health activity scheduling and data regarding one or more of daily total steps and work productivity.

10. The computing device of claim 1, wherein the instructions are executable to control a power state of the computing device based upon a current activity as determined from the health data and the work data.

11. The computing device of claim 1, wherein the instructions are executable to receive work data relating to a work schedule via one or more of user input, a personal calendar, Global Positioning System data, user input data, email data, and a work access monitoring system.

12. The computing device of claim 1, wherein the instructions are further executable to output one or more of a recommendation regarding a location to perform the health activity, a recommendation regarding one or more persons with whom to perform the health activity, and a recommendation of an activity to perform.

13. On a computing device, a method, comprising:
receiving health data relating to health behavior of one or more users, the health data comprising information regarding a relationship between health activity scheduling and health outcome;
receiving work data relating to work activities;
comparing the health data and the work data to determine a time in a work schedule at which to recommend performing a health activity; and
outputting a recommendation regarding the time in the work schedule to perform the health activity.

14. The method of claim 13, wherein receiving health data comprises receiving sensor data from a wearable device.

15. The method of claim 14, wherein receiving sensor data comprises receiving sensor data relating to one or more of heart rate, skin temperature, galvanic skin response, number of steps taken, calories burned, moving distances, standing time, sleep duration and sleep quality.

16. The method of claim 13, wherein the work activities comprise one or more of meetings, emails, web searches, locations, applications used, work schedules and work productivity.

17. The method of claim 13, wherein the health data comprise information regarding a relationship between health activity scheduling and one or more of a sleep outcome and an exercise benefit, and wherein the recommendation is based on the relationship between health activity scheduling and one or more of the sleep outcome and exercise benefit.

18. A computing device, comprising:
a logic device; and
a storage device comprising instructions executable by the logic device to
receive sensor data from a sensor system;
from the sensor data, determine health data relating to health behavior of one or more users, the health data comprising information regarding a relationship between health activity scheduling and health outcome,
receive work data relating to a work schedule,
compare the health data and the work data to determine a time in the work schedule at which to recommend performing a health activity,
output a recommendation regarding the time in the work schedule to perform the health activity, and
control a power state of the computing device based upon a current activity as determined from the health data and the work data.

19. The computing device of claim 18, wherein the health data comprise information regarding a relationship between health activity scheduling and one or more of sleep outcome and an exercise benefit, and wherein instructions are executable to output a recommendation based upon the relationship between health activity scheduling and the one or more of sleep outcome and exercise benefit.

20. The computing device of claim 18, wherein the instructions are further executable to control a power state of one or more of a desktop computing device, a mobile computing device, and a wearable computing device based upon a current activity as determined from the health data and the work data.
